(19) United States
(12) Patent Application Publication
(10) Pub. No.: US 2026/0234348 A1
(43) Pub. Date: Aug. 13, 2026

(54) POLYIMIDE FILM HAVING HIGH DIMENSIONAL STABILITY AND METHOD FOR PREPARING SAME

(71) Applicant: PI ADVANCED MATERIALS CO., LTD., Chungcheongbuk-do (KR)

(72) Inventors: Dong-Young KIM, Chungcheongbuk-do (KR); Dae-Geon YOO, Chungcheongbuk-do (KR); Dong-Young WON, Chungcheongbuk-do (KR)

(21) Appl. No.: 18/706,303

(22) PCT Filed: Oct. 31, 2022
(86) PCT No.: PCT/KR2022/016808

§ 371 Date: May 1, 2026

(30) Foreign Application Priority Data
Nov. 1, 2021 (KR) 10-2021-0147897

(51) Int. Cl. C08J 5/18; C08G 73/10

(52) U.S. Cl. CPC C08J 5/18; C08G 73/1042; C08G 73/1071; C08J 2379/08

(57) ABSTRACT

Provided are a polyimide film having excellent dimensional stability and having an expansion coefficient ratio, represented by equation 1 below, of greater than 0 and less than or equal to 2.5, and a method for preparing same. The polyamide film is prepared by means of an imidization reaction of a polyamic acid solution containing two or more types of acid dianhydride components and two or more types of diamine components, thereby satisfying the expansion coefficient ratio. <Equation 1> Expansion coefficient ratio=hygroscopic expansion coefficient (ppm/RH %)/thermal expansion coefficient (ppm/° C.)

### TECHNICAL FIELD

The present disclosure relates to a polyimide film having high dimensional stability and, more specifically, to a polyimide film having both high thermal dimensional stability and high dimensional stability against moisture and a method of forming the same.

### BACKGROUND ART

Polyimide (PI) is a polymeric material having the highest level of heat resistance, chemical compatibility, electrical insulation, chemical resistance, and weather resistance of all organic materials on the basis of an imide ring having excellent chemical stability along with a rigid aromatic main chain.

Polyimide films are attracting attention as a material for various electronic devices in need of the properties mentioned above.

Examples of microelectronic components to which a polyimide film is applied include flexible thin circuit boards with high circuit integration density to cope with weight reduction and size reduction in electronic products. In particular, a polyimide film is widely used as an insulating film for thin circuit boards.

The thin circuit board typically has a structure in which a circuit including a metal foil is formed on an insulating film. Such a thin circuit board is referred to as a flexible metal-clad laminate in a broad sense and, in a narrower sense, is sometimes referred to as a flexible copper-clad laminate (FCCL) when using a thin copper plate as a metal foil.

Methods of forming a flexible metal-clad laminate may, for example, include (i) a casting method in which a polyamic acid, a precursor of polyimide, is cast or applied onto a metal foil and then imidized, (ii) a metalizing method in which a metal layer is directly installed on a polyimide film through sputtering, and (iii) a laminate method in which a polyimide film and a metal foil are bonded using heat and pressure through a thermoplastic polyimide.

In particular, the metalizing method is a method of producing a flexible metal-clad laminate by, for example, sputtering a metal such as copper on a polyimide film having a thickness in a range of 20 to 38 μm to sequentially deposit a tie layer and a seed layer. This method is advantageous in forming ultrafine circuits in which a circuit pattern has a pitch of 35 μm or smaller and is widely used to manufacture flexible metal-clad laminates for chip on film (COF).

The polyimide film used for flexible metal-clad laminates manufactured by the metalizing method must have high dimensional stability. Although dimensional stability is typically measured by thermal dimensional stability, expressed by the coefficient of thermal expansion, dimensional stability against moisture, expressed by the coefficient of hygroscopic expansion, is gradually becoming more important as much as thermal dimensional stability.

In other words, there is a growing demand for polyimide films having both excellent thermal dimensional stability and dimensional stability against moisture. However, when actually designing a polyimide film having a structure in which the thermal dimensional stability is high while the coefficient of thermal expansion is low, a problem in that the dimensional stability against moisture decreases is emerging.

Therefore, there is an urgent need for a polyimide film in which both high thermal dimensional stability and high dimensional stability against moisture are compatible.

The foregoing background description is intended to provide an understanding of the background of the present disclosure and may include matters not known in the related art to those skilled in the field to which the technology belongs.

### DOCUMENT OF RELATED ART

### Patent Document

(Patent Document 1) Korean Patent Application Publication No. 2021-0057936

### DISCLOSURE

### Technical Problem

Accordingly, the present disclosure aims to provide a polyimide film having both high thermal dimensional stability and high dimensional stability against moisture.

However, the problems to be solved by the present disclosure are not limited to the above description, and other problems can be clearly understood by those skilled in the art from the following description.

### Technical Solution

In one aspect of the present disclosure for achieving the object as described above, a polyimide film having a value of an expansion coefficient ratio represented by Equation 1 below of higher than 0 and 2.5 or lower
is provided.

$$〈 Equation 1 〉$$

$$Expansion coefficient ratio = coefficient of hygroscopic expansion ( ppm / RH \% ) / coefficient of thermal expansion ( ppm / °C . )$$

In another aspect of the present disclosure, a flexible metal-clad laminate including a polyimide film and an electrically conductive metal foil
is provided.

In a further aspect of the present disclosure, an electronic component including a flexible metal-clad laminate
is provided.

### Advantageous Effects

The present disclosure provides a polyimide film in which the composition ratio, reaction ratio, and the like of acid dianhydride and diamine components are adjusted, thereby providing a polyimide film having both excellent thermal dimensional stability and dimensional stability against moisture.

Such a polyimide film can be applied to various fields in need of a polyimide film having excellent dimensional stability, for example, flexible metal-clad laminates manufactured by a metalizing method and electronic components including such flexible metal-clad laminates.

### BEST MODE

All terms including technical and scientific terms used herein have the same meaning as commonly understood by those skilled in the art to which the present disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Therefore, the embodiments described herein are merely examples and do not exhaustively present the technical spirit of the present disclosure. Accordingly, it should be appreciated that there may be various equivalents and modifications that can replace the embodiments and the configurations at the time at which the present application is filed.

As used herein, the singular forms are intended to include the plural forms as well, unless the context clearly indicates otherwise. It will be further understood that the terms “comprise”, “include”, “have”, and the like when used herein, specify the presence of stated features, integers, steps, components, or combinations thereof but do not preclude the presence or addition of one or more other features, integers, steps, components, or combinations thereof.

As used herein, although the term “acid dianhydride” is intended to include precursors or derivatives thereof, these compounds may not technically be acid dianhydride. Nevertheless, these compounds will react with diamine to form polyamic acids, which will be converted to polyimides once more.

As used herein, although the term “diamine” is intended to include precursors or derivatives thereof, these compounds may not technically be diamines. Nevertheless, these compounds will react with dianhydride to form polyamic acids, which will be converted to polyimides once more.

When an amount, concentration, other value, or parameter is given herein as a range, preferred range, or enumeration of preferred upper values and preferred lower values, it is to be understood to specifically disclose all ranges formed by a pair of any upper range limit or a preferred value and any lower range limit or a preferred value, regardless of whether the ranges are additionally disclosed.

When a range of numerical values is mentioned herein, this range is intended to include not only the endpoints but also all integers and fractions within the range, unless otherwise stated. The scope of the present disclosure is not intended to be limited to the specific values mentioned when defining the scope.

A polyimide film, according to one embodiment of the present disclosure, may have a value of an expansion coefficient ratio represented by Equation 1 below of higher than 0 and 2.5 or lower.

$$〈 Equation 1 〉$$

$$Expansion coefficient ratio = coefficient of hygroscopic expansion ( ppm / RH \% ) / coefficient of thermal expansion ( ppm / °C . )$$

Preferably, the value of the expansion coefficient ratio, represented by Equation 1, below is 1.0 or higher and 2.5 or lower.

The polyimide film having a value, represented by Equation 1 above, exceeding 2.5 involves a large dimensional change due to moisture and a small dimensional change due to heat, thus making it challenging to predict the dimensional change of the polyimide film.

In other words, when the humidity changes with changes in the surrounding environment, the extent of change in the dimensions of the polyimide film increases, making it difficult to control the dimensions through heat.

In one embodiment, the polyimide film may have a coefficient of thermal expansion of 1 ppm/° C. or higher and 7 ppm/° C. or lower and a coefficient of hygroscopic expansion of 3 ppm/RH % or higher and 10 ppm/RH % or lower.

Preferably, the coefficient of thermal expansion is 5.5 ppm/° C. or lower, and the coefficient of hygroscopic expansion is 9 ppm/RH % or lower. More preferably, the coefficient of thermal expansion is 5.0 ppm/° C. or lower, and the coefficient of hygroscopic expansion is 8 ppm/RH % or lower.

In one embodiment, the polyimide film may be obtainable by reacting a polyamic acid solution through an imidization reaction, the polyamic acid solution containing an acid dianhydride component including two or more selected from the group consisting of biphenyl-tetracarboxylic dianhydride (BPDA), pyromellitic dianhydride (PMDA), oxydiphthalic anhydride (ODPA), and benzophenone tetracarboxylic dianhydride (BTDA) and a diamine component including two or more selected from the group consisting of para-phenylenediamine (PPD), m-tolidine, oxydianiline (ODA), and 1,3-bis(aminophenoxy)benzene (TPE-R).

Additionally, the polyimide film may be obtainable by reacting the polyamic acid solution through the imidization reaction, the polyamic acid solution containing the acid dianhydride component including two or more selected from the group consisting of biphenyl-tetracarboxylic dianhydride, pyromellitic dianhydride, and benzophenone tetracarboxylic dianhydride, and the diamine component including two or more selected from the group consisting of para-phenylenediamine, m-tolidine, and oxydianiline.

On the other hand, the biphenyl-tetracarboxylic dianhydride may have a content of 60 mol % or less, the pyromellitic dianhydride may have a content of 40 mol % or more and 60 mol % or less, and the benzophenone tetracarboxylic dianhydride may have a content of 60 mol % or less, based on 100 mol % of the total content of the acid dianhydride component.

Preferably, the pyromellitic dianhydride has a content of less than 53 mol %, and the benzophenone tetracarboxylic dianhydride has a content of 50 mol % or less, based on 100 mol % of the total content of the acid dianhydride component.

Additionally, the para-phenylenediamine may have a content of 50 mol % or more and 95 mol % or less, the m-tolidine may have a content of 55 mol % or less, and the oxydianiline may have a content of 25 mol % or less, based on 100 mol % of the total content of the diamine component.

Preferably, the para-phenylenediamine has a content of 55 mol % or more and 90 mol % or less, the m-tolidine has a content of 50 mol % or less, and the oxydianiline has a content of 20 mol % or less, based on 100 mol % of the total content of the diamine component.

Additionally, when para-phenylenediamine and m-tolidine are used as the diamine components, the para-phenylenediamine may have a content of 50 mol % or more and 70 mol % or less, and the m-tolidine may have a content of 30 mol % or more and 45 mol % or less, based on 100 mol % of the total content of the diamine component.

In the present disclosure, with the increasing content of para-phenylenediamine, a rigid monomer, the polyimide synthesized has a further linear structure and contributes to the improvement of the mechanical properties of the polyimide.

Additionally, m-tolidine has a particularly hydrophobic methyl group and thus contributes to the low hygroscopicity related to the dimensional stability of the polyimide film with respect to moisture.

In the present disclosure, the polyimide chain derived from biphenyl-tetracarboxylic dianhydride has a structure called a charge transfer complex (CTC), that is, a regular linear structure in which an electron donor and an electron acceptor are positioned close to each other, and the intermolecular interaction is strengthened.

Such a structure is effective in preventing hydrogen bonding with moisture and thus has an impact on reducing the moisture absorption rate, thereby maximizing the effect of reducing the hygroscopicity, affecting the dimensional stability against moisture, of the polyimide film.

Additionally, pyromellitic dianhydride, the acid dianhydride component having a relatively rigid structure, is preferable in terms of providing appropriate elasticity to the polyimide film.

In order for the polyimide film to have excellent dimensional stability, the content ratio of the acid dianhydride is important. For example, as the content ratio of biphenyl-tetracarboxylic dianhydride decreases, a low moisture absorption rate based on the CTC structure is hard to expect, and the dimensional stability against moisture is reduced.

Additionally, while biphenyl-tetracarboxylic dianhydride and benzophenone tetracarboxylic dianhydride contain two benzene rings corresponding to the aromatic moiety, pyromellitic dianhydride contains one benzene ring corresponding to the aromatic moiety.

The increase in the content of pyromellitic dianhydride in the acid dianhydride component may be understood as an increase in the imide group within the molecule based on the same molecular weight, indicating that the ratio of the imide group derived from pyromellitic dianhydride in the polyimide polymer chain increases relatively compared to those of the imide groups derived from biphenyl-tetracarboxylic dianhydride and benzophenone tetracarboxylic dianhydride.

In other words, an increase in the content of pyromellitic dianhydride may be seen as a relative increase in the imide group in the entire polyimide film, making it difficult to expect high dimensional stability against moisture due to a low moisture absorption rate.

On the contrary, when the content ratio of pyromellitic dianhydride decreases, this means that the component having a relatively rigid structure is reduced, so the elasticity of the polyimide film may deteriorate below the desired level.

For this reason, when the contents of biphenyl-tetracarboxylic dianhydride and benzophenone tetracarboxylic dianhydride exceed the above ranges, or the content of pyromellitic dianhydride is lower than the above range, the dimensional stability of the polyimide film may be reduced.

On the contrary, when the content of pyromellitic dianhydride exceeds the above range, the dimensional stability of the polyimide film may be adversely affected.

In one embodiment, the ratio of the mol % of the pyromellitic dianhydride to the mol % of the para-phenylenediamine (mol % of the pyromellitic dianhydride/mol % of the para-phenylenediamine) may be 0.5 or higher and 0.8 or lower.

The preparation of a polyamic acid in the present disclosure may, for example, involve:
(1) a polymerization method by adding the entire amount of the diamine component in a solvent and then adding the acid dianhydride component so that the amount thereof is substantially equimolar to that of the diamine component;
(2) a polymerization method by adding the entire amount of the acid dianhydride component in a solvent and then adding the diamine component so that the amount thereof is substantially equimolar to that of the acid dianhydride component;
(3) a polymerization method by adding some of the diamine component to a solvent, mixing some of the acid dianhydride component in a ratio of about 95 to 105 mol % to the reaction component, adding the remaining diamine component, and then subsequently adding the remaining acid dianhydride component so that the diamine component and the acid dianhydride component are substantially equimolar;
(4) a polymerization method by adding some of the acid dianhydride component to a solvent, mixing some of the diamine compound in a ratio of about 95 to 105 mol % to the reaction component, adding the remaining acid dianhydride component, and then subsequently adding the remaining diamine component so that the diamine component and the acid dianhydride component are substantially equimolar;
(5) a polymerization method by reacting some of the diamine component and some of the acid dianhydride component in a first solvent so that either one is in excess to form a first composition, reacting some of the diamine component and some of the acid dianhydride component in a second solvent so that either one is in excess to form a second composition, and mixing the first and second compositions to complete polymerization, wherein when the diamine component is in excess when forming the first composition, the acid dianhydride component in the second composition is contained in an excessive amount, and when the acid dianhydride component is in excess in the first composition, the diamine component in the second composition is contained in an excessive amount to mix the first and second compositions so that the entire diamine component and acid dianhydride component used in the reaction are substantially equimolar; and the like.

In one specific example, a formation method of the polyimide film, according to the present disclosure, may include:
(a) preparing a polyamic acid by polymerizing an acid dianhydride component including two or more selected from the group consisting of biphenyl-tetracarboxylic dianhydride (BPDA), pyromellitic dianhydride (PMDA), oxydiphthalic anhydride (ODPA), and benzophenone tetracarboxylic dianhydride (BTDA) and a diamine component including two or more selected from the group consisting of para-phenylenediamine (PPD), m-tolidine, oxydianiline (ODA), and 1,3-bis(aminophenoxy)benzene (TPE-R) in an organic solvent; and
(b) imidizing the polyamic acid.

In the present disclosure, such a polymerization method of the polyamic acid described above may be defined as a random polymerization method. Additionally, the polyimide film of the present disclosure, formed from the polyamic acid prepared through such a process described above, is preferably applicable in terms of maximizing the effect of the present disclosure for increasing dimensional stability.

However, the polymerization method makes the length of the repeating unit in the polymer chain described above relatively short, so there may be limitations in demonstrating each of the excellent properties of the polyimide chain derived from the acid dianhydride component. Therefore, block polymerization may be performed as the polymerization method of the polyamic acid, which is further preferably usable in the present disclosure.

On the other hand, the solvent for synthesizing the polyamic acid is not particularly limited, and any solvent capable of dissolving the polyamic acid may be usable. However, an amide-based solvent is preferably used.

Specifically, the organic solvent may be a polar organic solvent, which may be, in particular, a polar aprotic solvent. Examples thereof may include one or more selected from the group consisting of N,N-dimethylformamide (DMF), N,N-dimethylacetamide, N-methyl-pyrrolidone (NMP), gamma-butyrolactone (GBL), and diglyme, but the organic solvent is not limited thereto. If necessary, the organic solvent may be used alone, or two or more types may be used in combination.

In one example, N,N-dimethylformamide and N,N-dimethylacetamide are further preferably used as the organic solvent.

Additionally, in the polyamic acid preparation process, fillers may be added to improve various properties of the film, such as sliding properties, thermal conductivity, corona resistance, loop hardness, and the like. The filler added is not particularly limited, but preferred examples thereof include silica, titanium oxide, alumina, silicon nitride, boron nitride, calcium hydrogen phosphate, calcium phosphate, mica, and the like.

The particle diameter of the filler is not particularly limited but may be determined depending on the properties of a film to be modified and the type of fillers to be added. Typically, the average particle diameter is in a range of 0.05 to 100 μm, which is preferably in the range of 0.1 to 75 μm, more preferably in the range of 0.1 to 50 μm, and even more preferably in the range of 0.1 to 25 μm.

When the particle diameter is smaller than the above range, the modification effect may be challenging to exhibit. On the contrary, when the particle diameter exceeds the above range, the surface properties may be greatly damaged, or the mechanical properties may significantly deteriorate.

Additionally, the amount of the filler added is not particularly limited but may be determined by the properties of a film to be modified, the particle diameter of the filler, or the like. Typically, the amount of the filler added is in a range of 0.01 to 100 parts by weight, which is preferably in the range of 0.01 to 90 parts by weight and more preferably in the range of 0.02 to 80 parts by weight, based on 100 parts by weight of the polyimide.

When the amount of the filler added is smaller than the above range, the modification effect may be challenging to exhibit due to the filler. On the contrary, when the amount of the filler added exceeds the above range, the mechanical properties of the film may be significantly damaged. The method of adding the filler is not particularly limited, and any known methods may be used.

In the formation method of the present disclosure, the polyimide film may be formed by a thermal imidization method and a chemical imidization method.

Additionally, the polyimide film may be formed by a complex imidization method in combination of the thermal imidization and the chemical imidization methods.

The thermal imidization method is a method of inducing an imidization reaction using a heat source such as an infrared dryer or hot air, without involving a chemical catalyst.

The thermal imidization method may enable the amic acid group present in a gel film to be imidized by subjecting the gel film to heat treatment at a variable temperature in a range of 100° C. to 600° C. Specifically, the heat treatment may be performed at a temperature in a range of 200° C. to 500° C., which is more specifically in the range of 300° C. to 500° C., to imidize the amic acid group present in the gel film.

However, even in the gel film formation process, some of the amic acid (about 0.1 mol % to 10 mol %) may be imidized. To this end, the polyamic acid composition may be dried at a variable temperature in a range of 50° C. to 200° C., which may also fall within the scope of the thermal imidization method.

In the case of the chemical imidization method, a dehydrating agent and an imidizing agent may be used according to methods known in the art to form the polyimide film.

As one example of the complex imidization method, a dehydrating agent and an imidizing agent may be introduced into a polyamic acid solution, heated at a temperature in a range of 80° C. to 200° C., which is preferably in the range of 100° C. to 180° C., partially cured and dried, and then heated at a temperature in a range of 200° C. to 400° C. for 5 to 400 seconds, thereby forming the polyimide film.

The present disclosure provides a flexible metal-clad laminate including the polyimide film described above and an electrically conductive metal foil.

The metal foil used is not particularly limited. However, when using the flexible metal-clad laminate of the present disclosure for electronic or electrical devices, the metal foil may, for example, include copper or an alloy thereof, stainless steel or an alloy thereof, nickel or an alloy thereof (including Alloy 42), and aluminum or an alloy thereof.

In typical flexible metal-clad laminates, copper foils, such as rolled copper foil and electrolytic copper foil, are widely used and are also preferably used in the present disclosure. Additionally, an anti-rust layer, a heat-resistant layer, or an adhesive layer may be applied onto the surface of such metal foils.

The thickness of the metal foil is not particularly limited in the present disclosure and may be any thickness capable of demonstrating sufficient functions depending on the intended use.

The flexible metal-clad laminate, according to the present disclosure, may have a structure in which metal foil is laminated on at least one surface of the polyimide film.

### MODE FOR INVENTION

Hereinafter, the action and effect of the present disclosure will be described in detail through specific examples and preparation examples of the disclosure. However, these examples and preparation examples are provided only for illustrative purposes, and the scope of the present disclosure is not limited to the following embodiments.

### Preparation Example: Polyimide Film Formation

A polyimide film of the present disclosure may be formed by typical methods known in the art, as follows. First, the acid dianhydride and diamine components mentioned above are allowed to react in an organic solvent to obtain a polyamic acid solution.

In this case, the solvent used, typically an amide-based solvent, is a polar aprotic solvent, which may be N,N′-dimethylformamide, N,N′-dimethylacetamide, N-methyl-pyrrolidone, or a combination thereof.

The acid dianhydride and diamine components are enabled to be introduced in a solution, powder, or lump form. Preferably, the reaction occurs by introducing the acid dianhydride and diamine components in a powder form at the beginning of the reaction and then in a solution form to control the polymerization viscosity.

The polyamic acid solution obtained in such a manner may be mixed with an imidization catalyst and a dehydrating agent so as to be applied onto a support.

Examples of the catalyst used include tertiary amines (for example, isoquinoline, β-picoline, pyridine, and the like), and examples of the dehydrating agent include anhydrous acids, but the catalyst and the dehydrating agent are not limited thereto. Additionally, the support used above may be a glass plate, aluminum foil, circular stainless steel belt, stainless drum, or the like, but is not limited thereto.

The film applied onto the support is turned into a gel form on the support by drying air and heat treatment.

The gel film formed in such a manner is separated from the support, subjected to heat treatment for drying, and then imidized.

The film obtained through the heat treatment above may be subjected to heat treatment under a predetermined tension to remove residual stress generated in the film during the film formation process.

Specifically, 500 ml of dimethylformamide (DMF) is introduced while injecting nitrogen into a reactor equipped with a stirrer and nitrogen injection/discharge pipes, and the reactor temperature is set to 30° C. Next, biphenyl-tetracarboxylic dianhydride (BPDA), pyromellitic dianhydride (PMDA), benzophenone tetracarboxylic dianhydride (BTDA), para-phenylenediamine (PPD), m-tolidine, and oxydianiline (ODA) are introduced in a controlled composition ratio in a predetermined order and completely dissolved. Then, the resulting product was heated by raising the reactor temperature to 40° C. under a nitrogen atmosphere with continuous stirring for 120 minutes. As a result, a polyamic acid having a primary reaction viscosity of 1,500 cP was prepared.

The polyamic acid prepared in such a manner was stirred to have a final viscosity in a range of 100,000 to 120,000 cP.

After adding the catalyst and the dehydrating agent to the prepared final polyamic acid by adjusting the contents thereof, a polyimide film was formed using an applicator.

### EXAMPLES AND COMPARATIVE EXAMPLES

In Examples 1 to 5 and Comparative Examples 1 to 7, each polyimide film was formed according to the preparation example by adjusting the contents of the acid dianhydride and diamine components, as shown in Table 1 below.

TABLE 1

| | Acid anhydride | | | Diamine | | |
|---|---|---|---|---|---|---|
| | BPDA | PMDA | BTDA | m-Tolidine | ODA | PPD |
| Example 1 | 50 | 50 | — | — | 13 | 87 |
| Example 2 | 50 | 50 | — | 40 | — | 60 |
| Example 3 | 47 | 53 | | 45 | — | 55 |
| Example 4 | — | 50 | 50 | 35 | — | 65 |
| Example 5 | 30 | 50 | 20 | 30 | — | 70 |
| Comparative | 50 | 50 | — | — | — | 100 |
| Example 1 | | | | | | |
| Comparative | 100 | — | — | — | — | 100 |
| Example 2 | | | | | | |
| Comparative | — | 100 | — | — | 75 | 25 |
| Example 3 | | | | | | |
| Comparative | 35 | 65 | — | — | 100 | — |
| Example 4 | | | | | | |
| Comparative | 50 | 50 | — | — | 100 | — |
| Example 5 | | | | | | |
| Comparative | 50 | 50 | | 25 | | 75 |
| Example 6 | | | | | | |
| Comparative | 47 | 53 | — | 60 | — | 40 |
| Example 7 | | | | | | |

The coefficient of thermal expansion (CTE), coefficient of hygroscopic expansion (CHE), and expansion coefficient ratio (CHE/CTE) of the produced polyimide film were measured. The results thereof are shown in Table 2 below.

TABLE 2

| | Physical properties | | |
|---|---|---|---|
| | CTE | CHE | |
| | (ppm/° C.) | (ppm/RH %) | CHE/CTE |
| Example 1 | 4.9 | 8.4 | 1.7 |
| Example 2 | 3.1 | 5.8 | 1.9 |
| Example 3 | 1.5 | 3.4 | 2.3 |
| Example 4 | 5.0 | 8.0 | 1.6 |
| Example 5 | 3.4 | 6.1 | 1.8 |
| Comparative Example 1 | 0.2 | 6.5 | 32.5 |
| Comparative Example 2 | 8.5 | 9.8 | 1.2 |
| Comparative Example 3 | 17.0 | 21.0 | 1.2 |
| Comparative Example 4 | 38.0 | 24.0 | 0.6 |
| Comparative Example 5 | 44.0 | 18.0 | 0.4 |
| Comparative Example 6 | 1.5 | 5.3 | 3.5 |
| Comparative Example 7 | 0.3 | 4.0 | 13.3 |

### (1) Measurement of Coefficient of Thermal Expansion

The coefficient of thermal expansion (CTE) was measured using a thermomechanical analyzer, a Q400 model purchased from TA. Each polyimide film was cut into a size of a width of 4 mm and a length of 20 mm. While applying a tension of 0.05 N under a nitrogen atmosphere, the resulting film was heated from room temperature to 400° C. at a speed of 10° C./min and then cooled again at a speed of 10° C./min to measure the slope from 50° C. to 200° C.

The coefficient of thermal expansion measured in such a manner is the average value of the coefficients of thermal expansion in the machine direction (MD) and transverse direction (TD) of the polyimide film.

### (2) Measurement of Coefficient of Hygroscopic Expansion

The coefficient of hygroscopic expansion (CHE) was determined by, while applying the minimum weight (about 1 g for a sample with a size of 25 mm×150 mm) to prevent the polyimide film from loosening, adjusting the humidity to 3% RH so that moisture is absorbed until being completely saturated to measure the dimension, adjusting the humidity to 90% RH thereafter so that moisture is absorbed in the same manner until being completely saturated to measure the dimension, and then measuring the dimensional change rate from both of the results at a humidity of 90% RH per relative humidity difference of 87%.

The coefficient of hygroscopic expansion measured in such a manner is the average value of the coefficients of hygroscopic expansion in the machine direction (MD) and transverse direction (TD) of the polyimide film.

As a result of the measurement, the polyimide films of Examples 1 to 5 had an expansion coefficient ratio of 0 or higher and 2.5 or lower, a coefficient of thermal expansion of 1 ppm/° C. or higher and 7 ppm/° C. or lower, and a coefficient of hygroscopic expansion of 3 ppm/RH % or higher and 10 ppm/RH % or lower.

In contrast, in Comparative Example 1, containing only para-phenylenediamine as one type of diamine component, the coefficient of thermal expansion was excessively reduced compared to the coefficient of hygroscopic expansion, resulting in a significant increase in the expansion coefficient ratio.

Additionally, in Comparative Example 2, using only biphenyl-tetracarboxylic dianhydride and para-phenylenediamine as the acid dianhydride and diamine components, respectively, the coefficient value of thermal expansion increased.

On the other hand, in Comparative Example 3, containing only pyromellitic dianhydride as one type of acid dianhydride component, the coefficient values of both hygroscopic expansion and thermal expansion increased.

Additionally, in Comparative Examples 4 and 5, containing only oxydianiline as one type of diamine component, the coefficient values of both hygroscopic expansion and thermal expansion significantly increased.

On the other hand, in Comparative Examples 6 and 7, in which the contents of m-tolidine and para-phenylenediamine were adjusted, the respective coefficient values of thermal expansion significantly decreased, compared to Examples 2 and 3, in which the dianhydride component, content ratio thereof, and diamine component were the same as those in Comparative Examples 6 and 7, respectively, resulting in an increase in the expansion coefficient ratio.

Therefore, the polyimide films of Examples 1 to 5 formed within the appropriate range herein were excellent in both thermal dimensional stability and dimensional stability against moisture. However, when formed without falling within the appropriate range herein, it was confirmed that the thermal dimensional stability and dimensional stability against moisture were challenging to be compatible.

In other words, it was confirmed that the polyimide film formed within the appropriate range herein was a polyimide film having compatible thermal dimensional stability and dimensional stability against moisture, having excellent dimensional stability, and satisfying various requirements enabling the use thereof in application fields.

The embodiments of the present disclosure regarding the polyimide film and the formation method thereof are only preferred embodiments that allow those skilled in the art to easily practice the present disclosure in the technical field to which the present disclosure belongs and are not limited to the examples described above. Accordingly, the scope of the present disclosure is not limited thereby. Thus, the true technical protection scope of the present disclosure should be defined by the technical spirit of the appended claims. Additionally, those skilled in the art will appreciate that various modifications, alternatives, and substitutions are possible, without departing from the scope and spirit of the present disclosure as disclosed in the accompanying claims. Furthermore, it is apparent that modifications capable of being easily embodied by those skilled in the art are included within the scope of the present disclosure.

### INDUSTRIAL APPLICABILITY

The present disclosure provides a polyimide film in which the composition ratio, reaction ratio, and the like of acid dianhydride and diamine components are adjusted, thereby providing a polyimide film having both excellent thermal dimensional stability and dimensional stability against moisture.

Such a polyimide film may be applied to various fields in need of a polyimide film having excellent dimensional stability, for example, flexible metal-clad laminates manufactured by a metalizing method and electronic components including such flexible metal-clad laminates.

1. A polyimide film having a value of an expansion coefficient ratio represented by Equation 1 of higher than 0 and 2.5 or lower.
$$〈 Equation 1 〉$$
$$Expansion coefficient ratio = coefficient of hygroscopic expansion ( ppm / RH \% ) / coefficient of thermal expansion ( ppm / °C . )$$

2. The polyimide film of claim 1, wherein the coefficient of thermal expansion is in a range of 1 ppm/° C. or higher and 7 ppm/° C. or lower, and
the coefficient of hygroscopic expansion is in a range of 3 ppm/RH % or higher and 10 ppm/RH % or lower.

3. The polyimide film of claim 1, wherein the polyimide film is obtainable by reacting a polyamic acid solution through an imidization reaction, the polyamic acid solution comprising:
an acid dianhydride component comprising two or more selected from the group consisting of biphenyl-tetracarboxylic dianhydride (BPDA), pyromellitic dianhydride (PMDA), oxydiphthalic anhydride (ODPA), and benzophenone tetracarboxylic dianhydride (BTDA); and
a diamine component comprising two or more selected from the group consisting of para-phenylenediamine (PPD), m-tolidine, oxydianiline (ODA), and 1,3-bis(aminophenoxy)benzene (TPE-R).

4. The polyimide film of claim 3, wherein the polyimide film is obtainable by reacting the polyamic acid solution through the imidization reaction, the polyamic acid solution comprising:
the acid dianhydride component comprising two or more selected from the group consisting of biphenyl-tetracarboxylic dianhydride, pyromellitic dianhydride, and benzophenone tetracarboxylic dianhydride; and
the diamine component comprising two or more selected from the group consisting of para-phenylenediamine, m-tolidine, and oxydianiline.

5. The polyimide film of claim 4, wherein the biphenyl-tetracarboxylic dianhydride has a content of 60 mol % or less,
the pyromellitic dianhydride has a content of 40 mol % or more and 60 mol % or less, and
the benzophenone tetracarboxylic dianhydride has a content of 60 mol % or less, based on 100 mol % of the total content of the acid dianhydride component.

6. The polyimide film of claim 4, wherein the para-phenylenediamine has a content of 50 mol % or more and 95 mol % or less,
the m-tolidine has a content of 55 mol % or less, and
the oxydianiline has a content of 25 mol % or less, based on 100 mol % of the total content of the diamine component.

7. The polyimide film of claim 3, wherein a ratio of the mol % of the pyromellitic dianhydride to the mol % of the para-phenylenediamine (mol % of the pyromellitic dianhydride/mol % of the para-phenylenediamine) is in a range of 0.5 or higher and 0.8 or lower.

8. A flexible metal-clad laminate comprising:
the polyimide film of any one of claims 1 to 7; and
an electrically conductive metal foil.

9. An electronic component comprising the flexible metal-clad laminate of claim 8.
